(19) United States
(12) Patent Application Publication
(10) Pub. No.: US 2005/0078118 A1
(43) Pub. Date: Apr. 14, 2005

(54) Table indexing system and method

(75) Inventors: John M. Airey, Mountain View, CA (US); Mark S. Peercy, Cupertino, CA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation, Redmond, WA (US)

(21) Appl. No.: 10/985,229

(22) Filed: Nov. 10, 2004

Related U.S. Application Data
(63) Continuation of application No. 09/569,650, filed on May 12, 2000.

(51) Int. Cl. G06T 1/20; G06F 13/00; G09G 5/39

(52) U.S. Cl. 345/531; 345/506; 345/536

(57) ABSTRACT

One aspect of the invention is a data retrieval system. The system (10) includes a memory (80) and a graphics system interface (15). The graphics system interface (15) is operable to control receiving a plurality of floating point pixel values (x). Each of the pixel values (x) includes a plurality of bits (101-116, 201-216), which include a plurality of mantissa bits (107-116, 202-211) and a plurality of exponent bits (102-106, 212-216). The graphics system interface (15) is also operable to control interpreting for at least one of the pixel values a contiguous subset of the bits as a fixed point value to produce a second data value (y). The graphics system interface (15) is also operable to control reading the second data value (y) from a data structure (300) resident in the memory (80).

### TECHNICAL FIELD OF THE INVENTION

The present invention relates in general to image graphics and more particularly to a table indexing system and method.

### BACKGROUND OF THE INVENTION

Graphics rendering and other visualization applications typically utilize accelerated hardware, firmware, and sometimes even software modules to perform compute-intensive rendering operations. These applications also utilize a graphics system interface such as OPENGL® or DIRECT3D® to control low-level graphics drawing operations in these accelerated modules. These operations include, but are not limited to, polygon specification and transformations, basic lighting control, and frame buffer operations such as blending and depth-buffering. Transformations usually correctly position one or more three-dimensional objects and then apply lighting and/or textures using the correct size and angles. OPENGL® utilizes a variety of low-level models such as textures, which may be defined for objects within scenes, and lighting models, which may define light sources and the manner in which surfaces in the scenes reflect light therefrom. Unfortunately, any increase in the quality of an object's appearance is typically associated with a decrease in processing speed. This decrease in processing speed is undesirable, especially for interactive applications.

Although these interfaces provide low-level models of graphics operations that may be performed by accelerated modules, they typically process geometry-based data, and thus limit the flexibility with which pixel-based complex effects may be programmed. For example, programmable or procedural shading applications usually involve pixel-based manipulation of the appearances of objects within a scene by an artist or technical director. Controlling the appearance of these objects typically requires the use of complex effects such as blending, shading, and texturing. For example, the artist may desire that a portion of a reflecting pool appear rippled and bright. These applications are desirably programmable to improve the flexibility and speed of manipulating the objects to achieve the desired result.

Many graphics systems may utilize lookup tables to compute appearance parameters that include, for example, colors and/or textures. Unfortunately, values computed in these systems are typically limited in range, or compressed by scaling, biasing, and/or clamping. This compression of values typically limits the accuracy and flexibility with which the appearances of objects may be computed.

### SUMMARY OF THE INVENTION

From the foregoing, it may be appreciated that a need has arisen for improving the accuracy with which table indices may be determined from floating point data values. In accordance with the present invention, a table indexing system and method are provided that substantially eliminate or reduce disadvantages and problems of conventional systems.

One aspect of the invention is a system for implementing an extended range texture. The system includes a memory and a graphics system interface. The graphics system interface is operable to control receiving a plurality of floating point pixel values. Each of the pixel values comprises a plurality of bits, which comprise a plurality of mantissa bits and a plurality of exponent bits. The graphics system interface is also operable to control interpreting for at least one of the pixel values a contiguous subset of the bits as a fixed point value to produce a second data value. The graphics system interface is also operable to control reading the second data value from a data structure resident in the memory.

The invention provides several important advantages. Various embodiments of the invention may have none, some, or all of these advantages. For example, the invention may be used to implement higher resolution values for operations such as texturing. The invention may also represent pixel values as an index to a texture value. Such an advantage allows more detailed features such as colors and/or textures to be applied to image data and avoids these texture values from being clamped in the graphics pipeline. Such an advantage may also minimize any loss in the precision of computed colors and/or texture values, improve the quality of the resultant images by improving the accuracy to which light and/or color may be displayed and/or processed. The invention may implement any monadic function by using, for example, a one-dimensional texture in conjunction with a graphics system interface such as OPENGL®. The invention may be used with a variety of existing systems and maximize a speed of processing while maintaining a minimum loss in precision of extended range pixel values. Other technical advantages may be readily ascertainable by those skilled in the art from the following figures, description, and claims.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, and in which:

FIG. 1 is a block diagram of a graphics system;

FIGS. 2A and 2B graphically illustrate examples of extended range pixel data; and

FIG. 3 graphically illustrates a method for representing extended range textures.

### DETAILED DESCRIPTION OF THE INVENTION

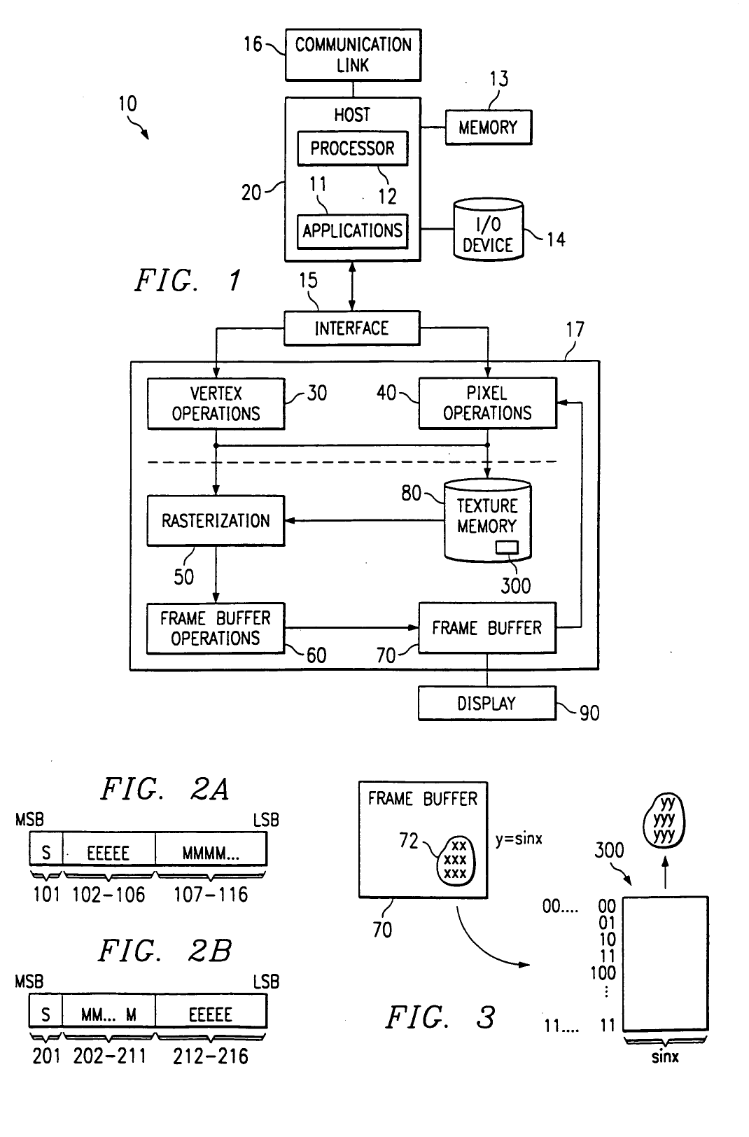

FIG. 1 is a block diagram of a graphics system 10. Graphics system 10 includes a host 20 coupled to a graphics system interface 15 which couples to a graphics pipeline 17. Host 20 may be a general or a specific purpose computer and includes a processor 12 and a memory 13, which may include random access memory (RAM) and read only memory (ROM). Specifically, host 20 may be used to execute applications 11 having image graphics and visualization software that may be stored in memory 13 and/or an input/output device 14. Results may be displayed using display 90 and/or stored in input/output device 14, which may be any suitable storage medium. Data processing may be performed using special purpose digital circuitry contained either in host 20 or in a separate device. Such dedicated digital circuitry may include, for example, application-specific integrated circuitry (ASIC), state machines, fuzzy logic, as well as other conventional circuitry. Host 20 may also include a portion of a computer adapted to execute any of the well known MS-DOS, PC-DOS, OS2, UNIX, MAC-OS, and Windows operating systems or other operating systems including nonconventional operating systems. Host 20 may also be coupled to a communication link 16 that may be connected to a computer network, a telephone line, an antenna, a gateway, or any other type of communication link.

Interface 15 may be any software graphics or firmware interface such as OPENGL® or DIRECT3D® that includes procedures and functions and that may be used to control low-level operations in graphics pipeline 17. In operation, interface 15 is operable to control the processing of image data in graphics pipeline 17 in response to selected commands that are passed from application software 11 such as a programmable shader. Data is passed through some or all of the elements in graphics pipeline 17 and may then be transferred from frame buffer 70 to display 90 for viewing. For example, pixels may be written to and read from frame buffer 70 using OPENGL® function calls such as the DrawPixels and ReadPixels command, and the function CopyPixels can be used to copy a block of pixels from one region of frame buffer 70 to another.

More specifically, graphics pipeline 17 includes a vertex operations module 30 and a pixel operations module 40. Vertex operations module 30 and pixel operations module 40 are each coupled to a rasterization hardware 50. Rasterization hardware 50 is coupled to a frame buffer operations module 60, which in turn is coupled to a frame buffer 70. Frame buffer 70 may couple to pixel operations module 40. Pixel operations module 40 is also coupled to a texture memory 80, which is also coupled to rasterization hardware 50. Graphics pipeline 17 may include software, firmware, hardware, or a combination thereof. Interface 15 may be a standalone module, reside on host 20, or a combination thereof.

It may be helpful to illustrate a single pass through graphics pipeline 17. Because interfaces 15 such as OPENGL® are procedurally based, graphics pipeline 17 performs those low-level operations on all of the pixels passed in response to the OPENGL® procedure or function call. Host 20 sends image data to pixel operations module 40, which may utilize a lookup table to apply a scale or bias such as a color contrast or brightness to pixels passed thereto. Host 20 also sends geometry data to vertex operations module 30. The geometry data usually includes texture coordinates or vertices (s,t,r,q) that are projected points that correspond to a location (x,y,z,w) in an image plane. The geometry data may also include normals at each of these vertices for each of the three channels (usually red, green, and blue). Vertex operations module 30 transforms geometry into a raster coordinate system. Usually, this includes tessellation, or breaking down a continuously smooth surface into triangular surfaces. Rasterization hardware 50 usually interpolates the tessellated vertices to populate the pixels within each of these surfaces. In some applications, rasterization hardware 50 may also request a texture map from texture memory 80 which is then applied to all of the pixels in rasterization hardware 50. These pixels are then passed to frame buffer 70.

Frame buffer operations module 60 then may perform a variety of functions on the data passed from rasterization hardware 50 and then pass this data to frame buffer 70. Some of these functions include, but are not limited to, a depth test, stencil test, and blending, and are performed on all of the pixels passed to frame buffer operations module 60. A depth test typically discards portions of an image region that fail a depth comparison. For example, the depth test may be used to clip surfaces that are further from, or are obstructed by, an object that is nearer in a field of view. A stencil test may be used as an arbitrary comparison that allows selected pixels to be rejected based on the outcome of a comparison between the value in the stencil buffer and the reference value, usually an integer. For example, one stencil test may include using a mask that may be used to compare with the reference so that the selected pixels may be passed. Another example may include indicating an action to take if the stencil test fails. For example, stencil bits may be incremented, decremented, or cleared to zero. Blending usually includes operations that may be performed on the pixels in the frame buffer, such as adds, subtracts, multiplies, or clears, and is typically used when assigning color values to pixels. An operation may be performed for each of the three color channels. When frame buffer 70 has performed this operation on all of the pixels, the pixels are usually sent to a display 90.

Where programmable applications 11 such as shading algorithms are used to model the appearance of objects, an artist typically describes the appearance of one or more portions of an image by selecting those pixels that should be altered. For example, a programmable shading algorithm may be used to provide various atmospheric, light, shading, surface details, textures, and/or colors. These functions may parameterize the appearance of selected objects.

These complex appearance effects typically result in different operations being performed on each resultant geometry-based vertex. One example may be a three-D lighting operation that models the diffuse reflection of colored, directional light sources from colored surfaces. Algorithms may use an illumination function that calculates the diffuse reflection of colored directional light for each vertex of a colored surface. For example, the illumination function for a single vertex is a vector dot product of the light source coordinates and the vertex normal, multiplied by the light color, the vertex material color, and the attenuation.

Application software 11 may reside on host 20 or may be a separate module. Any data upon which application software may operate, including scenes and any objects therein, may be referred to as image data. This image data may originate from memory in host 20 or in a separate storage medium (not explicitly shown). Application software 11 and image data residing on host 20 are used to illustrate one aspect of the invention. Interface 15 may couple host 20 to graphics pipeline 17 in some embodiments or couple a separate application program 11 to host 20 in others.

Application 11 may process one or more pixel-based portions of an image for a given geometry-based vertex by passing selected portions of image data through graphics pipeline 17 multiple times with different parameters. This allows interface 15 such as OPENGL® to be used as a single-instruction, multiple-data (SIMD) computing surface by using several basic OPENGL® functions in multi-pass operations that are called by application 11. One such function may include, for example, CopyTexImage which may be used to define a texture array from frame buffer 70. One such application 11 that may utilize interface 15 as a SIMD computing surface is one that utilizes the RenderMan shading language. Details for translating a shading language such as RenderMan into multiple passes through a graphics pipeline 17 driven by a graphics interface 15 such as OPENGL®, may be found in co-pending U.S. patent application Ser. No. 09/056,583, entitled “System and Method for High-Speed Execution of Graphics Application Programs Including Shading Language Instructions”, filed Apr. 8, 1998.

Bits of image pixel values may be preserved in this process to improve computational accuracy within graphics pipeline 17. For example, floating point values may be represented in at least a portion of graphics pipeline 17. One method for such representation is discussed in U.S. patent application Ser. No. 09/098,041, entitled “Display System Having Floating Point Rasterization and Floating Point Framebuffering”, filed Jun. 16, 1998. In addition, textures and/or colors may be applied to objects using interface 15 and retaining floating point pixel values rather than fixed-point data restricted to a range between zero to one. One example of a method that may be used to index textures and/or colors by using a lookup table is graphically illustrated in conjunction with FIG. 3. Any number of bits may be used to represent these pixel values. For example, one method for representing pixel data values may use a signed floating point system with a plurality of bits that may be divided between a sign portion, a mantissa portion, and an exponent portion. Furthermore, the arrangement of the plurality of bits may vary as desired. Two examples are illustrated in FIGS. 2A and 2B and are used to illustrate one aspect of the information. These pixel values include ten mantissa bits and five exponent bits. Where the exponent portion is biased from values between −16 and +15, the pixel values may range between −64K to +64K. The invention contemplates fewer or more total bits, mantissa bits, and/or exponent bits, and other arrangements for sign, mantissa, and exponent bits that may be suitable for a desired application and/or implementation.

FIG. 2A graphically illustrates one example of an extended range pixel representation where a pixel value may be represented by sixteen bits 101-116. Bits 101-116 range from a most significant bit (MSB) 101 to a least significant bit (LSB) 116. As illustrated in FIG. 2A, MSB 101 may be used as a sign bit. The next five most significant bits 102-106 may be used as exponent bits and bits 107-116 may be used as mantissa bits.

FIG. 2B graphically illustrates another example of an extended range pixel representation where a pixel value may be represented by sixteen bits 201-216. Bits 201-216 range from a most significant bit (MSB) 201 to a least significant bit (LSB) 216. As illustrated in FIG. 2B, MSB 201 may be used as a sign bit. In this embodiment, the next ten most significant bits 202-211 may be used as mantissa bits, and bits 212-216 may be used as exponent bits.

FIG. 3 graphically illustrates an example of a lookup table 300 in which pixel texture data may be represented. Although other values may be used to modify image appearance, texture values are used to illustrate one aspect of the present invention. Lookup table 300 may be used to represent a one-dimensional texture that may be applied to pixel values x within a region 72 of an image. A texture value is typically applied to pixel values x in frame buffer 70. Any monadic mathematical function may be implemented by use of lookup table 300 including, but not limited to, functions such as 1/(x), sin(x), cos(x), abs(x), floor(x), and tan(x). Use of lookup table 300 may improve processing speed and minimize the loss of precision that would otherwise result from clamping of pixel values in graphics accelerator module 17. The function sine will be used with a sixteen-bit extended range pixel value to illustrate one aspect of the present invention.

For each value x in region 72, a new texture value y=sin(x) may be applied thereto. Lookup table 300 includes extended range texture values for each pixel operation y=sin(x). That is, each x value entry may be used as an index to the contents of lookup table 300 that correspond to the texture values for that x entry, in this case a value of sin(x). In this embodiment, lookup table 300 includes 64K entries, one entry for each bit combination of sixteen-bit extended range pixel values x.

Lookup table 300 may be downloaded into pixel operations module 40 and/or saved in texture memory 80. For example, texture may be applied while image data is processed in rasterization module 50 and/or frame buffer 70 by utilizing lookup table 300 stored in either texture memory 80 or pixel operations module 40. In addition, a plurality of lookup tables 300 may be implemented for some or all monadic functions that may be used to alter the appearance of image data.

In addition, lookup table 300 may also utilize a subset of the one-dimensional texture that is represented by the 64K entries illustrated in FIG. 3. For example, lookup table 300 may also be implemented utilizing a selected majority of MSBs where the desired detail in texture may not require differentiation between one or more LSBs. To illustrate, lookup table 300 may include only those combinations that utilize seven of the most significant mantissa bits as illustrated in FIG. 2B, reducing the number of entries from 64K to 8K. Reducing the number of entries for lookup table 300 may desirably reduce memory and/or processing requirements.

The invention contemplates a variety of methods for implementing lookup table 300. For example, lookup table 300 may be implemented in firmware or software and/or in data structures such as tables, files, databases, or the like. Lookup table 300 may be implemented by using an interface 15 such as OPENGL® or DIRECT3D®. For example, an application program 11 that utilizes the Renderman shading language may use an OPENGL® CopyPixels call with pixel texgen bits enabled to invoke the indexed value y=sin(x) within lookup table 300.

Thus, it is apparent that there has been provided in accordance with the present invention, a table indexing system and method that satisfies the advantages set forth above. For example, the present invention allows the use of extended range pixel values with a graphics system interface. These values may be used to encode any monadic function (i.e., a function with a single operand) using a one-dimensional texture and to facilitate an improved appearance of scenes. Although the present invention has been described in detail, it should be understood that various changes, substitutions, and alterations may be readily ascertainable by those skilled in the art and may be made herein without departing from the spirit and scope of the present invention as defined in the following claims.

1. A method for retrieving data, comprising:
receiving a plurality of floating point pixel values each comprising a plurality of bits, the bits comprising a plurality of mantissa bits and a plurality of exponent bits;
interpreting for at least one of the pixel values a contiguous subset of the bits as a fixed point value to produce a second data value; and
reading the second data value from a memory.

2. The method of claim 1, further comprising reading the pixels from a second memory.

3. The method of claim 2, wherein the second memory is a frame buffer in a graphics system.

4. The method of claim 3, further comprising computing the pixel values by passing image data through the graphics system.

5. The method of claim 1, wherein the steps of receiving, interpreting and reading are performed using an application-specific integrated circuit.

6. The method of claim 1, wherein the image pixel values include a most significant sign bit, ten next significant exponent bits, and five least significant mantissa bits.

7. The method of claim 1, wherein the second data value is accessible using a graphics system interface that is operable to perform at least a subset of the functions of those performed by the graphics system interface sold under the trademark OPENGL®.

8. A data retrieval system, comprising:
a graphics pipeline having a memory; and
a graphics system interface operable to control receiving a plurality of floating point pixel values each comprising a plurality of bits, the bits comprising a plurality of mantissa bits and a plurality of exponent bits, the graphics system interface further operable to control interpreting for at least one of the pixel values a contiguous subset of the bits as a fixed point value to produce a second data value, the graphics system interface further operable to control reading the second data value from a data structure resident in the memory.

9. The system of claim 8, wherein the second data value is accessible using a graphics system interface that is operable to perform at least a subset of the functions of those performed by the graphics system interface sold under the trademark OPENGL®.

10. The system of claim 8, wherein the second data value is one of the group consisting of a texture value and a color value.

11. The system of claim 8, wherein the graphics system interface is further operable to control reading the pixel values from a second memory.

12. The system of claim 11, wherein the second memory is a frame buffer in a graphics system.

13. The system of claim 12, wherein the pixel values are derived from image data passed through the graphics system.

14. The system of claim 8, wherein the pixel values include a most significant sign bit, ten next significant exponent bits, and five least significant mantissa bits.

15. A data structure, comprising:
a computer readable medium; and
a data structure resident on the computer-readable medium, the data structure including a data value produced by interpreting for at least one of a plurality of floating point pixel values a contiguous subset of a plurality of bits as a fixed point value, and wherein each of the plurality of floating point pixel values each comprises the plurality of bits, the bits comprising a plurality of mantissa bits and a plurality of exponent bits.

16. The data structure of claim 15, wherein the data value is one of the group consisting of a texture value and a color value.

17. The data structure of claim 15, wherein the data value is accessible using a graphics system interface that is operable to perform at least a subset of the functions of those performed by the graphics system interface sold under the trademark OPENGL®.

18. The data structure of claim 15, wherein the image pixel values include a most significant sign bit, ten next significant exponent bits, and five least significant mantissa bits.

19. The data structure of claim 15, wherein the pixel values are read from a frame buffer in a graphics system.

20. The data structure of claim 19, wherein the pixel values are derived image data passed through the graphics system.
